(19) United States
(12) Patent Application Publication
(10) Pub. No.: US 2002/0152116 A1
(43) Pub. Date: Oct. 17, 2002

(54) Method and system for generating fixed and/or dynamic rebates in credit card type transactions

(76) Inventors: Kent J. Yan, Mountain View, CA (US); Haijun Li, Redmond, WA (US)

Correspondence Address: Kenneth Watov, Esq., Watov & Kipnes, P.C., P.O. Box 247, Princeton Junction, NJ, 08550, US

(21) Appl. No.: 09/816,915

(22) Filed: Mar. 23, 2001

Related U.S. Application Data
(60) Provisional application No. 60/265,050, filed on Jan. 30, 2001.

(51) Int. Cl. G06F 17/60

(52) U.S. Cl. 705/14; 705/39

(57) ABSTRACT

The present invention is directed to a method and system for dynamically generating and distributing rebates to a credit cardholder in response to credit card payment transactions initiated by the credit cardholder. The method comprises the steps of processing a credit card transaction initiated by a credit cardholder, storing transaction data corresponding to the credit card transaction in a transaction database, accessing the transaction data stored on the transaction database on a periodic basis to produce a billing statement listing a debt incurred by the credit cardholder, generating a dynamic rebate amount for effecting a discount of the incurred debt for the cardholder, and updating the billing statement to reflect the discount provided by the dynamic rebate amount.

### BACKGROUND OF THE INVENTION

Credit cards are typically plastic card-like members of a system which enables an authorized cardholder to pay for purchases of services and/or goods. Such credit cards are usually issued by a bank and provide a mechanism by which a cardholder purchases goods or services without an immediate, direct exchange of cash and thus incurs debt which the cardholder may thereafter (i.e. upon receipt of a monthly or otherwise periodic statement) either pay the outstanding balance or, as a matter of choice, defer the balance for later payment with accompanying interest or finance charges for the period during which payment of the debt is deferred. Typically, the credit card issuer renders such periodic billing statements to their cardholders which list all charges accrued interest.

Incentive programs are known in the prior art to be used in conjunction with credit card services. Credit card issuers have devised and implemented various incentive programs to increase credit card usage in purchase transactions. Incentive programs offered by credit card issuers have included low finance rate programs, customer loyalty programs, point awards based on transaction volume of charges, and promotional games. Well known and successful examples of such programs include credits cards co-sponsored by automobile manufacturers offering cardholders of up to a certain percentage rebate on cardholder purchase of respective automobiles, based on the volume of charges placed on the credit card, and airline-partnered credit cards which award the cardholder frequent flyer mileage on the basis of cardholder-accrued card charges.

All of these programs and others aim to offer awards and incentives to modify behavior of individual cardholders and to direct the customers to some predetermined action, such as applying for a credit card, increasing volume of charges, directing purchase of specific goods or services, and the like. Other goals include increasing awareness of service offerings, to launch new products, to attract attention of a newly identified market audience, and for other marketing purposes.

To fully utilize the potential of credit card purchasing systems, credit card issuers typically implement promotional tools to optimize participation by cardholders, for example, initiating purchases of goods and/or services with their credit cards. By permitting cardholders to “earn” awards based on purchases, the cardholders are encouraged to incur greater transaction volumes of charges.

Accordingly, based on the above discussion, there is a need for a form of customer incentive program for effectively attracting new customers and to induce current customers to make purchases of goods and/or services using their credit cards. There is further a need to provide methods for enhancing the value of a substantially conventional credit card so as to enhance a cardholder's or potential cardholder's perception of the desirability of holding or subscribing to the card, and encourage increased use of the card for its normal utility as a payment device. In order to satisfy these and other needs, it would, therefore, be desirable to provide a method and system for fixed and/or dynamically generated rebates to customers, particularly authorized cardholders in a manner whereby the cardholder is able to obtain a dynamically-generated rebate or be dynamically selected to receive a fixed rebate award. Such a rebate can conveniently be applied to debts incurred by purchase transactions with the corresponding credit card. The system and method of the present invention may be utilized at any retail site where credit card payments can be placed and accepted.

### SUMMARY OF THE INVENTION

The present invention is generally directed to a method and system for dynamically generating varying rebates to credit card customers and/or dynamically selecting a transaction or account for rebating, in a manner which attracts customers and induces them to purchase various products or services, make payments, transfer balance funds, and the like, with corresponding credit cards, while being simple and low-cost in design for implementation and management. In addition, the method and system permits sponsoring credit card issuers to easily store, modify, offer, track and administer the incentive programs embodied within the present invention.

More specifically, the present invention provides means for heightening credit card customer activity by including elements of chance and fortune by dynamically selecting transactions or accounts to receive a rebate and/or dynamically generating varying rebates for each customer and/or each transaction. The present invention effectively offers dynamic rewards or rebates to individual customers, which vary from customer to customer or from transaction to transaction, while enabling a sponsoring credit card issuer to retain significant control and predictability of the overall rebate/award disbursements incurred by such incentive programs. The programs provide for dynamically-generated rebate amounts to be drawn by the participating customer. The possibility or chance of obtaining a favorably large credit card rebate amount creates a sweepstake-like marketing effect, and effectively induces customers to purchase a range of products and services using the corresponding credit card of the sponsoring credit card issuer. In addition, the present invention permits a fixed rebate to be dynamically awarded to select cardholders' accounts or transactions in a sweepstake-like drawing. The method and system of the invention is further arranged to provide a sponsoring credit card issuer with means to closely plan rebate award disbursements in a substantially controlled manner even with the presence of chance.

In one aspect of the present invention, a method for generating rebates to a cardholder-initiated credit card transaction, the method comprising the steps of:

(a) maintaining in a storage device a database identifying a plurality of credit cardholders accounts and one or more outstanding credit card transactions initiated by authorized cardholders;

(b) periodically reading the database to retrieve data corresponding to the outstanding credit card transactions for a billing or rebating period; and

(c) generating a fixed and/or a dynamic rebate amount for effecting a discount applied to selected one or more credit card transactions or cardholders accounts initiated during the billing or rebating period.

In another aspect of the present invention, there is provided a system for generating rebates to a cardholder-initiated credit card transaction, where the system comprises:

a storage device;

a processor connected to the storage device;

the storage device storing a program for controlling the processor; and

the processor operative with the program for executing a method comprising the steps of:

(a) maintaining in a storage device a database identifying a plurality of credit cardholders accounts and one or more outstanding credit card transactions initiated by authorized cardholders;

(b) periodically reading the database to retrieve data corresponding to the outstanding credit card transactions for a billing or rebating period; and

(c) generating a fixed and/or a dynamic rebate amount for effecting a discount applied to selected one or more credit card transactions or cardholders accounts initiated during the billing or rebating period.

### BRIEF DESCRIPTION OF THE DRAWINGS

Various embodiments of the invention are described in detail below with reference to the drawings, in which like items are identified by the same reference designation, wherein:

FIG. 1 is a schematic block diagram illustrating suitable hardware system for providing information and data flow therebetween for an embodiment of the invention;

FIG. 2 is a flowchart illustrating the general steps in one embodiment of the present invention as implemented by the system shown in FIG. 1;

FIG. 3 is a flowchart illustrating the steps in one embodiment of the present invention carried out during the execution of the rebate generation procedure;

FIG. 4 is a flowchart illustrating the steps in one embodiment of the present invention carried out during the definition of the rebate parameters procedure;

FIG. 5 is a flowchart illustrating the steps in one embodiment of the present invention carried out during the execution of a fixed rebate generation procedure;

FIG. 6 is a flowchart illustrating the steps in one embodiment of the present invention carried out the execution of a deep sweepstake generation procedure; and

FIG. 7 is a flowchart illustrating the steps in one embodiment of the present invention carried out during execution of an average dynamic rebate generation procedure.

### DETAILED DESCRIPTION OF THE INVENTION

The present invention is generally directed to a system and method for inducing customers to increase credit card usage and volume of charges using an associated credit card in purchase transactions for goods and/or services, devised in a manner that provides a credit card issuer the capability to retain significant control and predictability of overall rebate/award disbursements incurred by an incentive program of the present invention. The method and system of the present invention is designed with the advantage often associated with games of chance, but with the predictability and control desired by the sponsoring credit card issuer. The method and system of the present invention may be implemented in a simple, cost-efficient manner, to permit easy implementation with existing credit card processing and billing mechanisms.

As used herein, the term “debt” or “transaction volume” is intended to collectively encompass all monetary obligations incurred by an authorized cardholder of the credit card, and all monies owed to the issuer of the credit card for any and all forms of credit for prior or future transactions extendible to the cardholder or subscriber to the credit card's services. Examples of such transactions include services, purchased goods, cash advances or loans, subscription fees, credit balance transfers, applied finance charges, payment collections, and the like. Similarly, the term finance charges or rates should be understood as including, but not being limited to late fees, interest charges, bank fees and all other charges and assessments added to debts directly incurred by a cardholder through transactions such as purchases, balance transfers, cash advances, balance carry-overs, and the like. The finance charges most commonly result from the cardholder's decision to extend an outstanding balance due as of a particular billing period closing date.

Furthermore, any general or special purpose credit or bank card or similar or equivalent instrument or mechanism, whether or not represented or implemented in the form of a physical card or member or the like, through or in accordance with which an authorized cardholder executes a transaction (and thereby incurs debts) with an obligation to repay to the credit card or instrument issuer or sponsor is intended to be subsumed, for purposes of this disclosure, under the term “credit card” as used herein.

The methods of the present invention provide an authorized cardholder of a credit card, who incurs debts on or with the card, with an award (i.e. dynamically generated rebate, fixed rebate) that itself represents an opportunity, on the basis of the debts incurred with the credit card, to recover at least a portion of the total amount of the incurred debts. In one embodiment of the present invention, there are three modes for generating rebate awards. One mode is generating fixed rebates for all transactions in a given segment, n, as designated by the sponsoring card issuer. The second mode comprises awarding a deep sweepstake rebate wherein a transaction or an account is dynamically selected for a fixed discount percent as designated by the sponsoring card issuer. The third mode comprises awarding a dynamic rebate which may be applied to all or a select number of transactions in a given group or segment where the actual rebate awarded varies from transaction to transaction or from account to account. Each of the modes may be executed jointly or severally depending on the needs and desires of the sponsoring card issuer.

The greater the card-based debts incurred in number and volume, the greater the number of dynamic or sweepstake rebates that may be awarded and, correspondingly, the greater the cardholder's statistical chance of recovering at least a portion of the incurred debts. Thus, in another sense the invention provides methods for encouraging increased use of a card issuer's credit card by providing the cardholder with an opportunity to recover at least a portion of the incurred debts, since the opportunity and likelihood of recovery increase with increasing number and volume of card-based debt. In still another sense, the present invention provides gaming methods involving the incurring of debts on or with credit cards, and the award of gaming opportunities with increasing likelihood of an award resulting from increased numbers of cardholder-initiated credit card transactions including purchases, balance transfers, cash advances, payment collections, and the like. The methods of the present inventions applies to all transactions associated with credit cards where discrete transfer of funds whether on paper or electronic as debt incurred by the cardholder.

With the foregoing overview in mind, the detailed operation of the inventive methods are described for implementation in a data processing or computerized system.

It should further be noted that it is common in the credit card industry that cardholders or subscribers are billed on a periodic basis, most typically once a month, by generation of a billing statement itemizing the debts incurred during the preceding period, listing any new finance charges assessed or due on the new debts, and any existing carry-over balance from the preceding billing period. Also provided is an indication of the total amount that the cardholder now owes to the issuer of the credit card, and of a minimum amount or portion of that total that must be paid by a particular due date. It is accordingly assumed, for purposes of and to facilitate the following description of the currently preferred embodiments of the invention, that the method steps hereinafter described are for the most part practiced at or soon after each billing period closing date. Nevertheless, those skilled in the art will readily recognize and appreciate that the disclosed methods are subject to and may be suitably modified, as general matters of design choice, to accommodate different billing periods and end of rebating periods, and procedures and/or different manners of entering or recording incurred debts of and received payments from a cardholder of the card. For example, although in this description it has generally been assumed that all debts incurred by a cardholder during the billing period or cycle are entered into the data processing system on a bulk processing basis shortly after the billing period closing date, the invention is equally applicable to (and, indeed, includes accommodation for) implementations in which the individual debts or transactions are dynamically entered throughout the billing period and only those actions required to generate the end-of-period statement and to distribute to the cardholder the appropriate number of earned rebates that are effected shortly after the closing date. All such modifications should in any event be understood as being within the fully intended scope and contemplation of the invention.

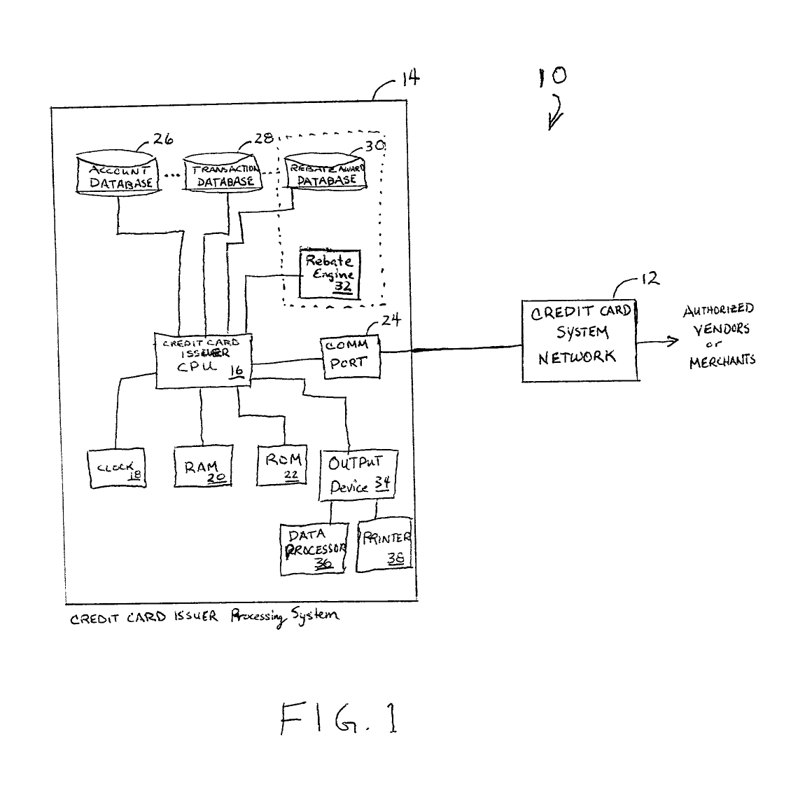

An embodiment of the method and system of the present invention will now be discussed with reference to FIGS. 1 to 7. Referring to FIG. 1, an embodiment of a hardware system 10 of the present invention is shown for illustrating the information flow between relevant parties during the implementation of the method of the present invention. The hardware system 10 executes, among other programs, an incentive award program of the present invention as managed by a credit card issuer or data processing service, and serves as the credit card issuer's processing system. The hardware system 10 of the present invention may be preferably implemented as part of a pre-existing credit card system network 12 in which the authorized merchants are in network communication with the credit card issuer or data processor. It is understood that the credit card system network 12 may be connected by any communication link including but not limited to, serial port cables, Internet, fiber optical networks, wireless radio frequency networks, telephone lines, local area networks, and the like. Such a credit card system network 12 is extended worldwide for transmitting credit card-based transactions and data flow between the credit card issuer and various merchants. As shown in FIG. 1, a credit card processor 14 communicates via the credit card system network 12 with authorized merchants who are typically connected therewith via point of sale terminals (not shown). Such point of sale terminals comprises a processor, such as one or more microprocessors, which is connected to a card reader for reading input from credit cards and a data storage device, such as RAM, floppy disk, hard disk, or combination thereof. The point of sale terminals collect transaction data and transmit it to the credit card processor 14 through the credit card system network 12. This transaction data is stored by the credit card processor 14 and is used to manage the account of the credit cardholder.

While the illustrative embodiment is described in the context of a traditional point of sale environment, it is noted that goods or services purchased in a remote retailing environment are within the scope of the present invention as well. A remote retailing transaction, as used herein, is any transaction outside of the traditional point of sale environment. A remote retailing transaction includes purchases of goods or services, such as magazine subscriptions, membership services or catalog purchases, made by a cardholder from a merchant, such as a direct merchant, remotely via, for example, telephone, mail, the Internet, or a shared revenue service, such as a 900 or 976 telephone number service. Included are cash-based advances, debt balance transfers, pre-authorized payments, and the like.

As shown in FIG. 1, the credit card processor 14 includes a central processing unit (CPU) 16, a clock 18, a random access memory 20, a read only memory 22, a communication port 24, and one or more storage devices 26, 28, and 30.The CPU 16 is preferably linked to each of the other listed components, by means of a shared data bus or dedicated connections. The processor 14 may be configured as a single unit device or comprised of one or more individual components spread out at different locations, and communicating through a network or the like. The communication port 24 provides a connection between the credit card system network 12 and the credit card processor 14. The dynamic credit rebate server/engine 32 may be part of the credit card processor 14 and access directly by the CPU 16, or located at a different site connected by a communication link such as the Internet, for example.

The storage device 26 stores a database of account information of participating cardholders. The credit cardholder account database 26 preferably stores biographical information on each cardholder, as well as the credit limit associated with each credit card account. The storage device 28 stores a database of transaction data transmitted from the authorized merchants in connection with purchases made by authorized cardholders using credit cards. The transaction database 28 preferably stores information required by the credit card issuer processor 14 for each transaction initiated by a cardholder, including billing description and purchase amount, and/or transaction volume. The information stored in the transaction database 28 may be utilized by the credit card processor 14 to generate the credit card billing statements. It is understood that the databases 26 and 28 can be stored on the same storage device. The storage device 30 stores a database of rebate award information as generated by the dynamic credit rebate server/engine 32. The storage devices 26, 28, and 30 are preferably a magnetic disk drive, but alternatively a CD-ROM drive, optical disk drive, RAM drive, or any other convention memory storage device can be used. The credit card processor 14 may further include an output device 34 for, among other things, transmitting the resulting periodic billing and rebating information to a data processor 36 or to a printer 38 for generating a periodic billing/rebating statement for cardholders. It is noted that the rebate engine 32 and rebate award database 30 are shown separately for conceptual purposes, and may be installed on a single device apart and separate from the credit card issuer processor 14, for example.

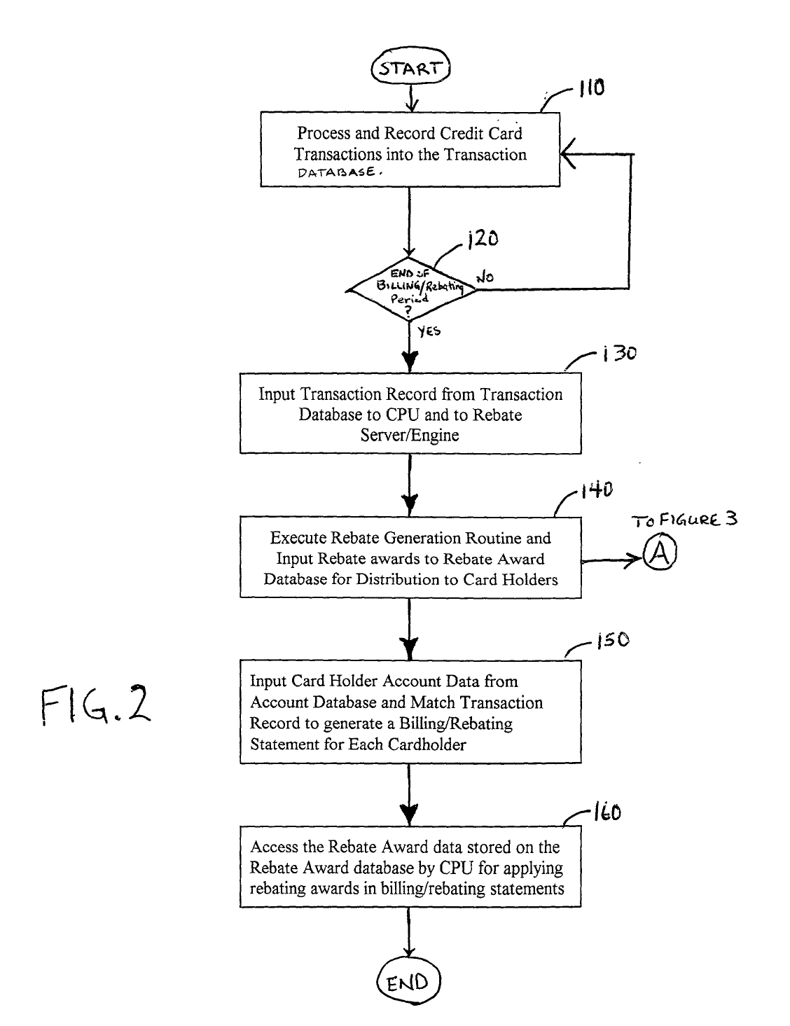

Referring now to FIG. 2, a process overview for carrying out the method of the present invention will be described. As shown at step 110, the routine processes and records validated credit card transactions initiated by authorized cardholders, e.g., when a cardholder purchases goods or services from a merchant and provides a credit card for payment. It is noted that the transaction may be part of a traditional point-of-sale transaction, wherein the cardholder and merchant may communicate face-to-face, a remote retailing transaction or other debt-incurring transaction. At step 120, the routine continues to monitor via the clock the date to determine if the closing date of the current billing and/or rebate period has passed. If the closing date has passed, the routine proceeds to step 130 where it inputs the transaction data stored in the transaction database 28 into the CPU 16 and into the dynamic credit rebate server 32. The CPU 16 processes the information in preparation of generating a billing statement. The rebate server 32 processes the information in preparation of generating rebate awards as will be described.

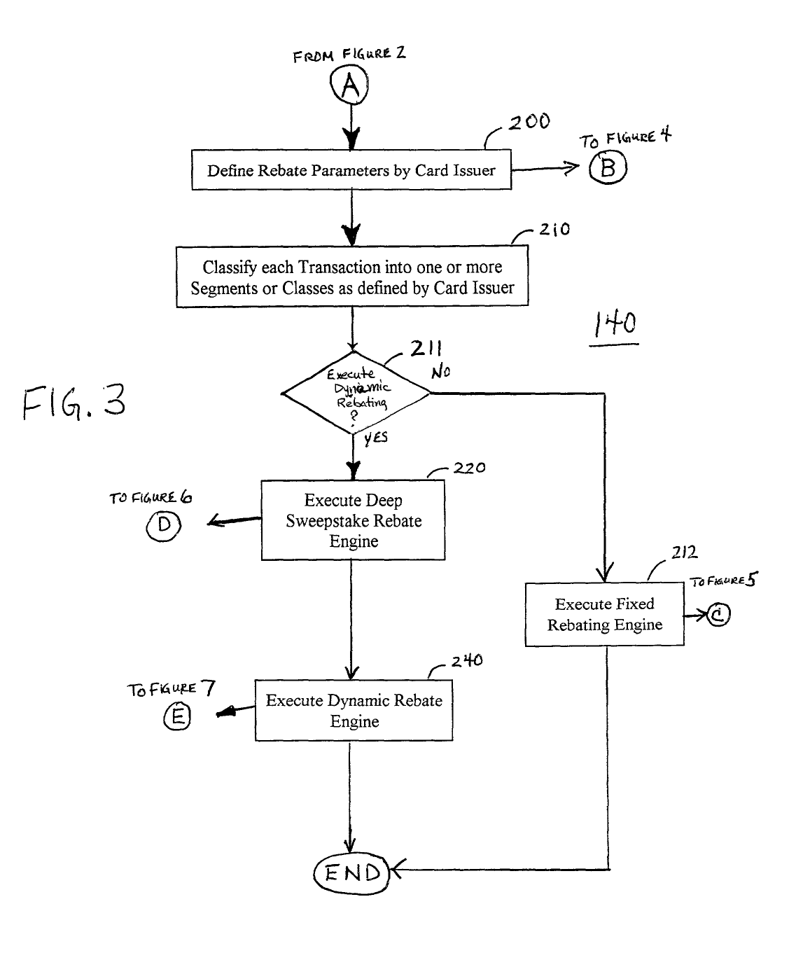

The routine then proceeds to step 140 to initiate a rebate generation engine which is illustrated in greater detail in FIG. 3. Step 140 ends when the record of the generated rebate awards are stored in the rebate award database 30. At step 150 in FIG. 2, the billing statement is generated by the CPU 16 utilizing the data information extracted from the transaction database 28 and the cardholder account database 26. The routine then proceeds to step 160 where the billing statement is modified to reflect the rebate award discounts for fulfilling the generated rebates to the corresponding cardholders.

In one embodiment of the present invention, the method comprises two primary states of operation. The system may be configured to award fixed rebates, or dynamic rebates which include generation deep sweepstake awards and dynamic rebate awards depending on the needs and the desires of the sponsoring card issuer.

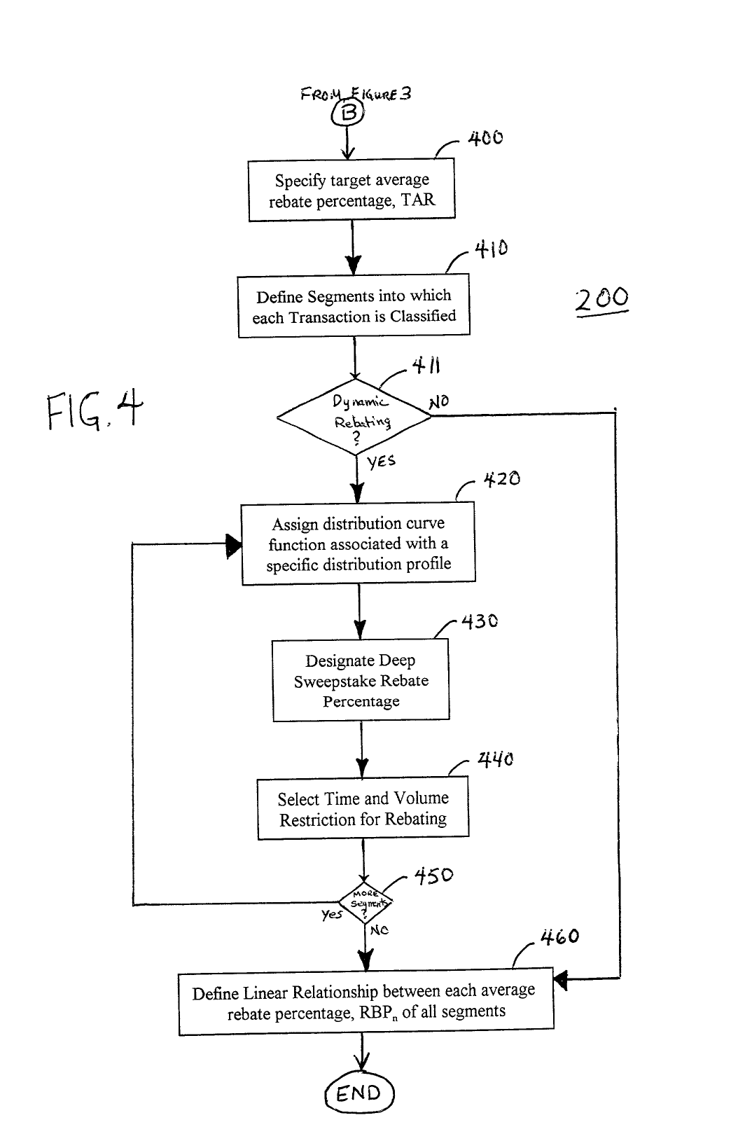

With reference to FIG. 3, a flowchart illustrating the steps for carrying out the rebate generation engine of step 140 (FIG. 2) is shown. At step 200, the rebate server 32 receives rebate parameters as defined and designated by the credit card issuer for executing the rebate generation engine. The process steps for defining the rebate parameters at step 200 is further detailed in the flowchart of FIG. 4 as will be described hereinafter. The routine proceeds to step 210 of FIG. 3 where the transactions for the current billing period are grouped into corresponding marketing segments of the cardholders as defined by the card issuer.

The segment can be defined by variables representing an average quarterly or monthly charge volume, an average quarterly or monthly outstanding balance, an average default performance and an average number of transactions per month. Of course, credit card issuers may define numerous alternative segment types including, but not limited to, monthly principle payments, annual purchases at specific merchants and balance transfer amounts. The card issuer may also define each segment according to different demographics, profitability, geographic regions, transaction volume or cycle, volume per account, affiliations, vendor or merchant patronage, new channel usage (Internet, for example), risk, time control (mew/old accounts, teaser rebate periods, seasonal periods, holidays, etc.), volume control, for example, delinquency status, point scoring systems, and the like.

Alternatively, the card issuer may set up a point system which reflects performance targets to classify each transaction. Many of these criteria are also tracked for individual cardholders. One skilled in the art will recognize various criteria which may be used to determine performance criteria in an effort to identify and reward certain cardholder behavior.

One method presently employed by credit card issuers to predict and influence cardholder behavior is determining a score defined by a scoring system. Scoring systems are mathematical models designed to provide probabilities of future performance based on a creditor's actual historic performance. Models are developed from past behavior and data relationships are used to identify predictive variables. Scoring systems can be used as absolute decision tools, or in combination with judgmental and expert system rules.

Credit card issuers currently use scores to determine: who will respond to an offer; who will reliably repay credit; and who will generate revenue for a lender. These scores are known as response scores, risk scores and revenue scores, respectively. Response scores are used to determine how to modify solicitations for maximum results and for areas of the country that have the greatest growth potential for specifically designed card products like insurance or investment cross-sells.

Risk scores are used to predict delinquencies and bankruptcies. They are also used to predict the extent and timing of monthly payments. Revenue scores assign a ranking to individuals by the relative amount of revenue they are likely to produce over a period of time following score assignment. Revenue scores help issuers in account management by identifying inactive accounts that ought to be targeted with an appropriate offer and by identifying the most desirable prospects for acquisition.

A risk score may also be classified as either a credit score or a behavior score. A credit score is a statistical measure used by creditors to determine whether to extend credit in the form of a loan, or as a credit line on a credit card. Credit scores takes into account many factors, including: annual income, years at current job, residence, debt payment history, current debt obligations and long term debt obligations. Creditors may assign different weights to these criteria to compute a credit score.

A behavior score is another statistical measure used by issuers to better manage individual accounts to maximize profit per account. The behavior score can include more than 50 different characteristics, including: extent of monthly payments, promptness of payment, use of card for purchases, balance transfers or cash advances, size and type of purchases and types of spending categories among others.

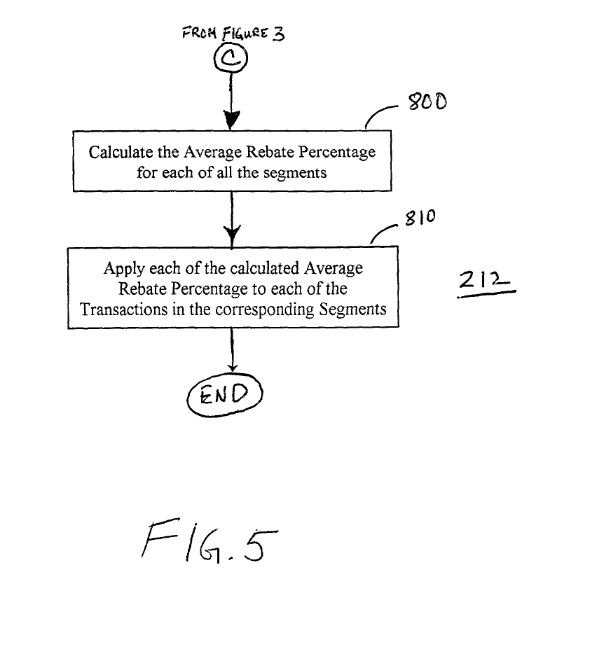

Upon classifying each transaction into a segment, the routine proceeds to step 211 where it queries whether the card issuer selected fixed rebating state of operation. If the answer is “Yes”, the routine executes the fixed rebating engine for generating fixed rebate percentages or amounts and applying such rebate percentages or amounts to all respective transactions or accounts in a given segment, n, for all segments. The fixed rebate engine as represented by step 212 is shown in greater detail in the flowchart of FIG. 5 and will be described hereinafter. Once the fixed rebates are awarded and distributed, the rebate generation routine is completed.

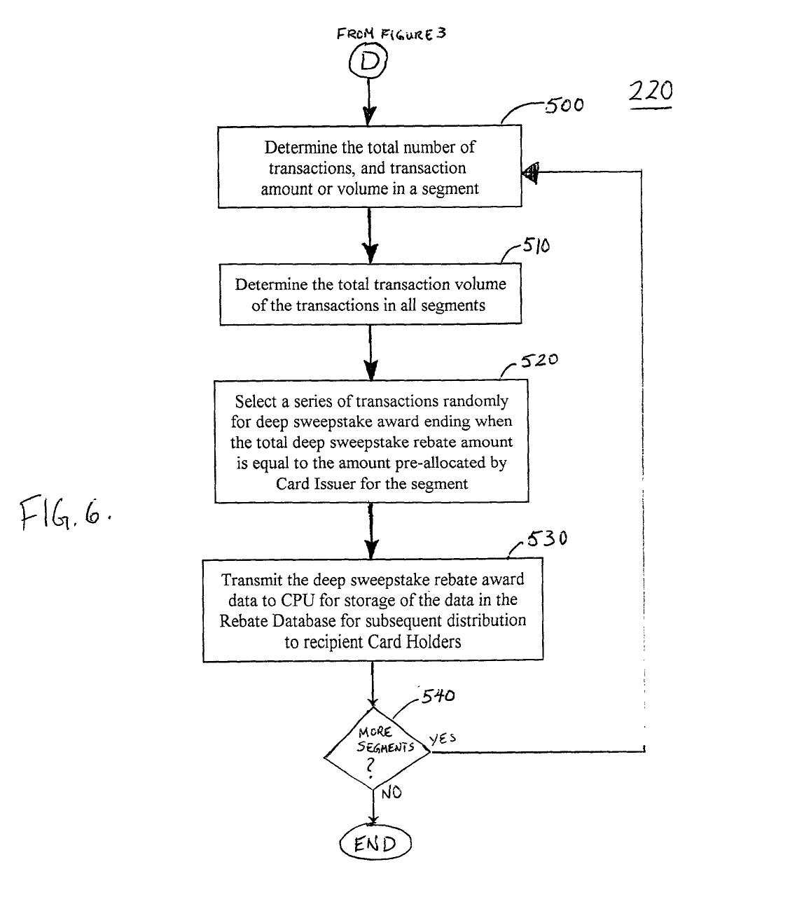

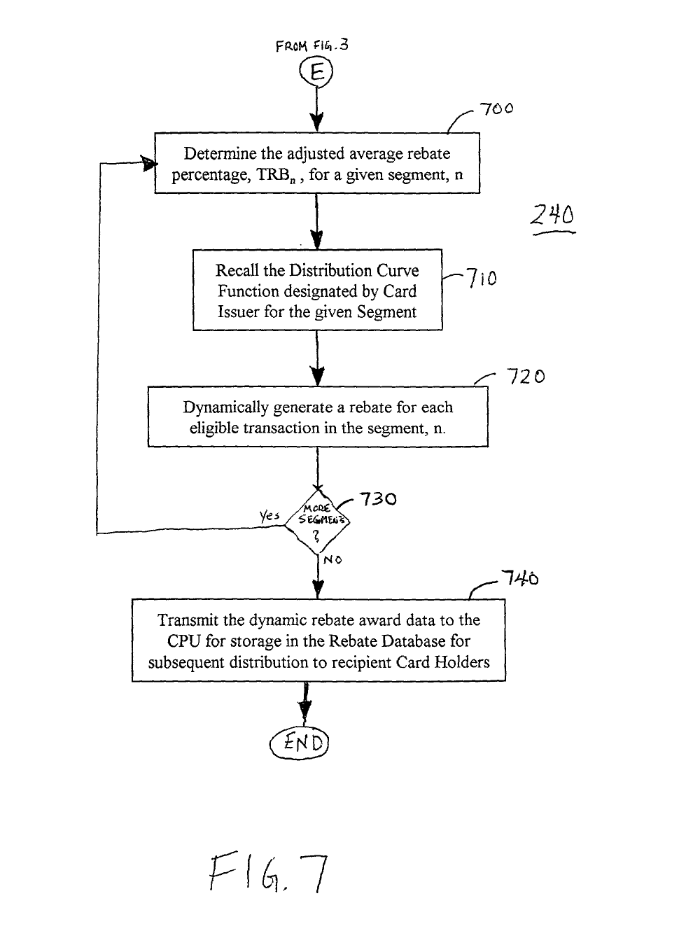

If the answer is no, the routine proceeds to step 220 of FIG. 3. The routine executes a deep sweepstake rebate engine for applying rebate percentages or amounts to dynamically selected transactions or accounts. The deep sweepstake rebate engine as represented by step 220 is shown in greater detail in the flowchart of FIG. 6. Upon generating the deep sweepstake rebate award, the routine proceeds to step 240 of FIG. 3, where the average dynamic rebate engine is executed. The average dynamic rebate engine of step 240 (as shown in FIG. 3) is shown in greater detail in the flowchart illustrated in FIG. 7, as described below.

Referring to FIG. 4, the flowchart shows the steps for defining the parameters of the routine as represented at step 200 of FIG. 3. At step 400, the card issuer designates the target average rebate, TAR, for all the eligible transactions or accounts of the current billing/rebating period. This provides the card issuer with control over the amount of rebating that the card issuer is willing to award the cardholders for the billing/rebating period. At step 410, the card issuer defines the segments for transactions eligible for rebate discounts that are grouped and classified as discussed above. The routine then proceeds to step 411 where it determines whether the rebating will be fixed or dynamically based. If the routine is set for fixed rebating by the card issuer, then the routine proceeds to step 460 where the linear relationship between each average rebate percentage, RBPₙ, of all segments is defined as described below. The RBPₙ is the percent at which the fixed rebate is based on in a given segment, n, and is a critical variable for calculating the adjusted target average rebate percentage, TRBₙ, for designating the mean percent value of the distribution function for the dynamic rebate state of operation. The target average rebate percentage is the average of the dynamic rebate percentage awarded within a given segment, n.

Alternatively, if the routine is set for dynamic rebating by the card issuer, then the routine proceeds to step 420, where the card issuer assigns a distribution curve function which corresponds to a level of award generosity for a segment as will be described below. The distribution curve statistically approximates the range and frequency of rebate percentages and amounts and the number receiving a particular rebate amount or percentage within a given segment, n. The distribution curve function is associated with the dynamic rebate award process as will be described below.

Next, at step 430, the card issuer determines and fixes a sweepstake rebate amount or percentage, DRPₙ, to be awarded to the selected transactions or accounts in a given segment, n. At step 440, the card issuer may limit the number of eligible transactions or accounts entitled to receive a fixed and/or sweepstake and dynamic rebate by selecting a specified volume range for each type of rebating (i.e. fixed rebate, sweepstake rebate, dynamic credit rebate) to set a transaction volume filter. The card issuer may also limit the number of eligible transactions or activity to those executed within a specific time frame or period. At step 450, the routine then determines if there are additional segments for which a set of parameters is required. If “Yes” then steps 420 thru 440 are repeated. Otherwise, the routine proceeds to step 460 where the card issuer defines a linear relationship between the respective target average rebate percentage variables of each segment, RBP₁, RBP₂, . . . , RBP_{n,}wherein “n” indicates the segment sequence number. The rebate relationship may be specified in the following manner,

$$\begin{matrix}R B {P}_{2} = {X}_{2} \cdot R B {P}_{1} \\ R B {P}_{3} = {X}_{3} \cdot R B {P}_{1} \\ ⋮ ⋮ ⋮ \\ R B {P}_{n} = {X}_{n} \cdot R B {P}_{1}\end{matrix} \qquad ( 1 )$$

wherein 0<X₂, X₃, . . . , Xₙ<1 as designated by the card issuer. In this manner, the RBP of each segment is dependent on the Xₙ. of the other segments and the RBP, corresponding in a linear relationship.

Referring to FIG. 5, the flowchart shows the steps for executing the fixed rebate engine as represented at step 212 of FIG. 3. At step 800, the engine proceeds to calculate the RBPₙ for each segment using the linear rebate relationship described above. To obtain the RBPₙ, the engine calculates the total volume of a segment to obtain TVₙ. This is repeated for each segment. The total volume, TV, is determined by adding all individual TVₙ of each segment by the following equation,

TV=TV₁+TV₂+TV₃+. . . +TVₙ (2).

The RBPₙ is then determined for each segment using the following equations:

RBP₁·TV₁+RBP₂TV₂+RBP₃TV₃+. . . +RBPₙ, TVₙ=TAR·TV (3);

RBP₁=TAR·TV/(TV₁+X₂·TV₂+X₃·TV₃+. . . +Xₙ·TVₙ) (4);

and

$$\begin{matrix}R B {P}_{2} = {X}_{2} \cdot R B {P}_{1} \\ R B {P}_{3} = {X}_{3} \cdot R B {P}_{1} \\ ⋮ ⋮ ⋮ \\ R B {P}_{n} = {X}_{n} \cdot R B {P}_{1} ,\end{matrix} \qquad ( 1 )$$

wherein TAR is the target average rebate and the series of Xₙ were previously specified by the card issuer.

Upon calculating the RBP for each segment at step 800, each of the calculated rebate percent, RBP, is applied to all of the transactions in the corresponding segment in the form of fixed rebates at step 810. Upon determining and awarding the fixed rebate to all the segments, the execution of the fixed rebating engine at step 212 of FIG. 3 is completed.

Referring to FIG. 6, the flowchart shows the steps for executing the deep sweepstake rebate engine as represented at step 220 of FIG. 3. At step 500 of FIG. 6, the engine for generating the deep sweepstake rebates, first determines the total number of transactions in each segment as represented by variables TN₁, TN₂, . . . , TNₙ, where “n” represents the segment sequence number. The engine then determines the total transaction volume in each segment as represented by variables TV₁, TV₂, . . . , TVₙ, where “n” represents the segment sequence number. Next, at step 510, the total transaction volume of all segments, TV, is determined by adding all the transaction volumes of each segment together. The equation used for determining the total transaction volume, TV, is represented as follows.

TV=TV₁+TV₂+. . .+TVₙ (5)

wherein “n” represents the segment sequence number.

At step 520, the engine selects the individual transactions which will be awarded a sweepstake rebate, DRP,, as designated by the card issuer. The engine accomplishes this task by first generating a uniform distribution dynamic fraction, u, where u is a number between 0 and 1. The dynamic fraction, u, is then used to determine a transaction number, Tₘ where “m” represents the transaction sequence number in a given segment, n. The transaction number, Tₘ, correlates with a specific transaction in the given segment, n. The transaction number is obtained using the following equation:

Tₘ=u·TNₙ (6)

where “m” represents the selected transaction sequence number. The Tₘ selected is awarded the deep sweepstake rebate, DRPₙ, previously defined by the card issuer at step 430 of FIG. 4. The actual rebate award amount for the first selected transaction, Tₘ, is denoted as Aₘ which is calculated using the following equation,

AₘTVₘₙ·DRPₙ (7)

wherein TVₘₙ is the transaction volume of the m^{th} transaction in the given segment, n, selected for the deep sweepstake rebate. Each of Aₘ is retained in memory as the selection of the transactions for the deep sweepstake award proceeds. The series of Aₘ is sunned to yield the total deep sweepstake rebate amount, TDRₙ for the nth segment. For each transaction selected for award, the resulting TDRₙis compared to the limit set aside by the card issuer for the deep rebate, SDR, represented as

SDRₙ=TVₙ·RBPₙ·Yₙ (8)

wherein Yₙ is the percentage of the total rebate assigned for deep rebate awards as designated by card issuer, and its value is less than 1. The selection process proceeds as long as TDRₙis less than SDRₙ. When TDRₙ is greater than or equal to SDRₙ, then the transaction selection process terminates. If the TDRₙis greater than the SDRₙ, the last transaction selected is disqualified from receiving the deep rebate. This feedback feature prevents or minimizes the total amount of the deep rebate award from exceeding the amount originally allocated by the card issuer.

At step 530 of FIG. 6, the deep sweepstake rebate information generated by the dynamic credit rebate engine/server 32 is transmitted to the CPU 16 for storage in the rebate award database 30. At step 540, the engine determines if there are additional segments for which the deep sweepstakes are to be awarded. If “yes”, then steps 500 through 530 are repeated.

Referring to FIG. 7, the flowchart illustrates the steps corresponding with executing the average dynamic rebate amount calculation engine at step 240 of FIG. 3. At step 700, the engine proceeds to calculate the RBPₙ, for each segment using the linear rebate relationship described above. To obtain the RBPₙ, the engine calculates the total transaction volume of a segment to obtain TVₙ. This is repeated for each segment. The total transaction volume, TV, is determined by adding all individual TVₙof each segment by the following equation,

TV=TV₁+TV₂+TV₃+ . . . +TVₙ (2).

The RBPₙis then determined for each segment using the following equations:

RBP₁·TV₁+RBP₂·TV₂RBP₃·TV₃+. . . +RBPₙ·TAR ·TV (3);

RBP₁=TAR·TV/(TV₁+X₂·TV₂+X₃TV₃+. . . +XₙTVₙ) (4);

and

$$\begin{matrix}R B {P}_{2} = {X}_{2} \cdot R B {P}_{1} \\ R B {P}_{3} = {X}_{3} \cdot R B {P}_{1} \\ ⋮ ⋮ ⋮ \\ R B {P}_{n} = {X}_{n} \cdot R B {P}_{1}\end{matrix} \qquad ( 1 )$$

wherein TAR is the target average rebate previously specified by the card issuer. Upon calculating the RBPₙ for a given segment, n, at step 700, the calculated rebate percent, RBPₙ, along with other variables, are inputted into the following equation,

TRBₙ=(TVₙ−RBPₙ−TDRₙ)/(TVₙ−(TDRₙ/DRPₙ)) (9)

The equation provides an adjusted target average rebate percentage, TRBₙfor the dynamic rebate awards in association with the deep sweepstake rebate award amount. The target average rebate percentage, TRBₙ, is the average of the dynamic rebate percentage awarded within a given segment, n. Accordingly, TRBₙ is the total dynamic rebate amount divided by the difference of the total transaction volume for the given segment, n, and the transaction volume of the transactions selected for the deep rebate awards. The TRBₙ variable is utilized in the corresponding distribution curve function for dynamically generating the rebates for distribution as described below.

At step 710, the routine recalls the distribution curve function algorithm previously assigned to a segment by the card issuer at step 410 of FIG. 4. At step 720, the routine dynamically generates a rebate for each transaction which has not been awarded a deep rebate, in a given segment, n, as will be described below. At decisional step 730, the routine determines if there are any segments that have not been awarded dynamically generated rebates. If “Yes”, then the routine repeats steps 700 through 720. Otherwise, the routine proceeds to step 740, where the dynamically generated rebate information is transmitted to the CPU 16 for storage in the rebate award database 30.

As to the distribution curve function algorithms, the card issuer, for example, can select a “generous” or “conservative” distribution scheme reflecting a particular level of award generosity. A more detailed description of the mathematical foundation for the distribution curve function algorithm used by the dynamic credit rebate server/engine 32 is provided by either one of two approaches shown and described below.

For “generous” distribution function, the dynamic rebate percentage for a given transaction, m, in a given segment, n, DRₘₙ, is obtained by the following equations,

DRₘₙ=MinRₙ+(MaxR_{n-Min}Rₙ)·u (10)

MinRₙ=X_{nMin}·TRBₙ ( 11)

MaxRₙ=(2·TRBₙ)−(X_{nMin}·TRBₙ) (12)

where MinRₙ, is the minimum rebate percentage, MaxRₙ is the maximum rebate percentage, u is a uniform distribution fraction u(0,1), a dynamic number between 0 and 1, TRBₙis the adjusted target average rebate percentage, and X_{nMin} is a parameter less than one as specified by the card issuer. Accordingly, for each transaction not awarded a deep sweepstake rebate, the dynamic rebate percentage for a given transaction is dynamically obtained and awarded. The dynamic rebate amount, DRBₘₙ for the corresponding transaction may then be calculated using,

DRBₘₙ=TVₘₙ·DRₘₙ (13)

where TVₘₙ is the transaction volume of the transaction, m, of the segment, n.

For “conservative” distribution function, the dynamic rebate percentage for a given transaction, m, in a given segment, n, or DRₘₙ, is obtained in the following manner.

Generate a uniform distribution fraction u(0, 1), or u, for the given transaction. The dynamic rebate amount, DRBₘₙ, is obtained using the following equations.

μ=TRBₙ (14)

σ=TRBₙ/2/k (15)

wherein k>1 and represents the toughness parameter;

$$D {R}_{m n} = \frac{[ {u}^{0.135} - {( 1 - u )}^{0.135} ]}{0.1975} ; and \qquad ( 16 )$$

Dynamic Rebate Amount=DRBₘₙ=TVₘₙ[μ+σ·DRₘₙ] (17)

where TVₘₙ is the transaction volume of the given transaction, m, in the given segment, n, to be rebated. It is understood that the mathematical basis for distribution of dynamically generated rebates is not limited to the above examples, and includes other statistical distribution functions as known to one skilled in the art.

In the event where a transaction that was awarded a rebate, is later revoked (i.e. customer returns goods for a refund), the engine 32 will search to determine the amount of rebate received and calculates the difference between the original sale payment and the rebate amount discounted. This difference is then refunded to the cardholder as reflected in the form of a credit on the periodic billing statement. Alternatively, the refunding merchant or vendor may be informed of the refund amount minus the rebate awarded in the event that a cash refund is requested.

Although various embodiments of the invention have been shown and described, they are not meant to be limiting. Those of skill in the art may recognize various modifications to these embodiments, which modifications are meant to be covered by the spirit and scope of the appended claims. For example, although the preferred embodiment of the invention includes an engine which calculates the dynamic rebate amounts incorporating a particular statistical distribution function, it is also contemplated that the present invention may alternatively utilize a memory-stored table of varying predetermined dynamic discount award amounts from which the discount awards may be selected for discounting during the business transaction to accomplish the goals of the invention.

What is claimed is:

1. A method for generating rebates to a cardholder-initiated credit card transaction, the method comprising the steps of:
(a) maintaining in a storage device a database identifying a plurality of credit cardholders accounts and one or more outstanding credit card transactions initiated by authorized cardholders;
(b) periodically reading said database to retrieve data corresponding to said outstanding credit card transactions for a billing or rebating period; and
(c) generating a fixed and/or a dynamic rebate amount for effecting a discount applied to selected one or more credit card transactions or cardholders accounts initiated during said billing or rebating period.

2. The method of claim 1, further comprising the steps of:
generating an account statement for each of said plurality of credit cardholders accounts separately listing each of said credit card transactions including the generated fixed and/or dynamic rebate amounts for effecting said discount; and
transmitting said account statement, respectively, to each of the authorized credit cardholders.

3. The method of claim 1, wherein the rebate generation step further comprising the steps of:
receiving from a credit card issuer a set of rebate parameters corresponding to a rebate amount which said credit card issuer desires to award for the billing or rebating period;
classifying each of said plurality of credit card transactions into one or more card issuer defined segments; and
generating a fixed sweepstake rebate for dynamically selected cardholders accounts or credit card transactions in each defined segment.

4. The method of claim 1, wherein the rebate generation step further comprising the steps of:
receiving from a credit card issuer a set of rebate parameters corresponding to a rebate amount which said credit card issuer desires to award;
classifying each of said plurality of credit card transactions into one or more card issuer defined segments; and
generating a dynamic rebate for selected ones of the cardholders accounts or the credit card transactions in each segment.

5. The method of claim 1, wherein the rebate generation step further comprising the steps of:
receiving from a credit card issuer a set of rebate parameters corresponding to a rebate amount which said credit card issuer desires to award for the billing or rebating period;
classifying each of said plurality of credit card transactions into one or more card issuer defined segments;
generating one or more sweepstake rebates for dynamically selected ones of the cardholders accounts or the credit card transactions in each segment;
determining an average dynamic rebate amount remaining based on total sweepstake rebate amount awarded, and the total rebate amount set by the credit card issuer; and
generating one or more dynamic rebates for selected ones of the cardholders accounts or the credit card transactions in each segment.

6. The method of claim 5, wherein the parameter receiving step further comprising the steps of:
defining by said card issuer the segments into which each transaction is classified;
assigning a distribution curve function for each defined segment;
defining a percentage of the total rebate amount to be awarded as deep sweepstake rebate awards in each defined segment;
defining a sweepstake rebate amount or percentage for each defined segment; and
defining the cardholders accounts or the transactions which are eligible to be awarded said sweepstake rebates based on transaction volume and/or transaction time for each defined segment.

7. The method of claim 6, wherein the parameter receiving step further comprising the steps of:
defining a linear relationship between an average rebate percentage of each defined segment; and
defining a target average rebate.

8. The method of claim 5, wherein the sweepstake rebate generation step further comprising the steps of:
determining total number and volume of the credit card transactions in each segment;
determining total transaction volume of all segments;
determining an amount limit for awarding sweepstake rebates in each defined segment;
selecting in a dynamic manner the transaction or cardholder to be awarded a sweepstake rebate in each defined segment; and
repeating the selection step until the amount limit for awarding the sweepstake rebates is reached in each defined segment.

9. The method of claim 8, wherein the dynamic transaction or cardholder selection step further comprising the steps of:
assigning each transaction or cardholder in the segment a sequence number;
generating a uniform distribution dynamic fraction, u(0,1), or u; and
inputting the uniform distribution dynamic fraction, u(0,1), or u, the total number of transactions or cardholders accounts in the segment, TN, into the following equation:
Tₘ=u·TN
to obtain the sequence number of the transaction or cardholder to be awarded the sweepstake rebate.

10. The method of claim 5, wherein the average dynamic rebate amount determining step further comprising the steps of:
adding all transaction volumes of the selected transactions or cardholders accounts in each segment;
determining total sweepstake rebate amount awarded for each segment; and
determining the difference between the rebate amount said credit card issuer desires to award, and the total sweepstake rebates awarded in each segment.

11. The method of claim 7, wherein the dynamic rebate generation step further comprising the steps of:
determining a target average rebate percentage, TRBₙ, for each defined segment based on the card issuer defined average rebate percentage linear relationship; and
dynamically generating a rebate for each transaction or cardholder within each of the defined segment using an algorithm implementing the card issuer assigned distribution curve function.

12. The method of claim 11, wherein the distribution curve function algorithm comprises the steps of:
generating a uniform distribution dynamic fraction, u(0,1) or u;
inputting the variable TRBₙ, or target rebate percentage of segment n, and card issuer selected parameter, X_{nMin}, into the following equations:
MinRₙ=X_{nMin}·TRBₙ
MaxRₙ=(2·TRBₙ)−(X_{nMin}·TRBₙ)
to obtain MinRₙ, which is less than the average rebate percentage, and maximum rebate percentage, MaxRₙ, respectively;
inputting the generated variables u, MinRₙ, and MaxRₙ, into the following equation:
DRₘₙ=MinRₙ+(MaxRₙ−MinRₙ)·u
to obtain a dynamically generated rebate percentage, DRₘₙ, of transaction, “m”, in segment, “n”;
inputting the dynamically generated rebate percentage, DRₘₙ, and the transaction volume of the corresponding transaction, into the following equation:
DRBₘₙ=TVₘₙ·DRₘₙ
to obtain a dynamically generated rebate amount, DRBₘₙ.

13. The method of claim 11, wherein the distribution curve function algorithm comprises the steps of:
generating a uniform distribution dynamic fraction, u(0,1) or u;
inputting a toughness parameter, k, and the target average rebate percentage, TRBₙ, for the segment, into the following equation:
$$σ = \frac{T R {B}_{n}}{2 \cdot k}$$
to obtain σ;
inputting said uniform distribution dynamic fraction, u(0,1) or u into the following equation:
$$D R {B}_{m n} = \frac{[ {u}^{0.135} - {( 1 - u )}^{0.135} ]}{0.1975}$$
to obtain a dynamic rebate percentage, DRBₘₙ;
inputting said uniform distribution dynamic fraction, u(0,1) or u, DRBₘₙ, σ, a transaction volume of the corresponding transaction, TVₘₙ, and the average rebate percentage into the following equation:
Dynamic Rebate Amount=TVₘₙ[TRBₙ+σ·DRBₘₙ]
to obtain the dynamically generated rebate award amount.

14. The method of claim 1, further comprising the step of:
storing in said storage device distributed rebate data corresponding to rebates applied to respective credit card transactions of said cardholders;
receiving request from a merchant user for refund amount information corresponding to a revoked transaction of a cardholder;
reading said distributed rebate data corresponding to the revoked transaction;
calculating the refund amount by subtracting the rebate applied to said revoked transaction from the transaction volume of the revoke transaction and; and
transmitting said refund amount information to said merchant user in order to administer a refund to said cardholder.

15. A system for generating rebates to a cardholder-initiated credit card transaction, the system comprising:
a storage device;
a processor connected to the storage device;
the storage device storing a program for controlling the processor; and
the processor operative with the program for executing a method comprising the steps of:
(a) maintaining in a storage device a database identifying a plurality of credit cardholders accounts and one or more outstanding credit card transactions initiated by authorized cardholders;
(b) periodically reading said database to retrieve data corresponding to said outstanding credit card transactions for a billing or rebating period; and
(c) generating a fixed and/or a dynamic rebate amount for effecting a discount applied to selected one or more credit card transactions or cardholders accounts initiated during said billing or rebating period.

16. The system of claim 15, wherein the processor is further operative for:
generating an account statement for each of said plurality of credit cardholders accounts separately listing each of said credit card transactions including the generated fixed and/or dynamic rebate amounts for effecting said discount; and
transmitting said account statement, respectively, to each of the authorized cardholders.

17. The system of claim 15, wherein the rebate generation step further comprising the steps of:
receiving from a credit card issuer a set of rebate parameters corresponding to a rebate amount which said credit card issuer desires to award for the billing or rebating period;
classifying each of said plurality of credit card transactions into one or more card issuer defined segments; and
generating a fixed sweepstake rebate for dynamically selected cardholders accounts or credit card transactions in each defined segment.

18. The system of claim 15, wherein the rebate generation step further comprising the steps of:
receiving from a credit card issuer a set of rebate parameters corresponding to a rebate amount which said credit card issuer desires to award;
classifying each of said plurality of credit card transactions into one or more card issuer defined segments; and
generating a dynamic rebate for selected ones of the cardholders accounts or the credit card transactions in each segment.

19. The system of claim 15, wherein the rebate generation step further comprising the steps of:
receiving from a credit card issuer a set of rebate parameters corresponding to a rebate amount which said credit card issuer desires to award for the billing or rebating period;
classifying each of said plurality of credit card transactions into one or more card issuer defined segments;
generating one or more sweepstake rebates for dynamically selected ones of the cardholders accounts or the credit card transactions in each segment;
determining an average dynamic rebate amount remaining based on total sweepstake rebate amount awarded, and the total rebate amount set by the credit card issuer; and
generating one or more dynamic rebates for selected ones of the cardholders accounts or the credit card transactions in each segment.

20. The system of claim 19, wherein the parameter receiving step further comprising the steps of:
defining by said card issuer the segments into which each transaction is classified;
assigning a distribution curve function for each defined segment;
defining a percentage of the total rebate amount to be awarded as deep sweepstake rebate awards in each defined segment;
defining a sweepstake rebate amount or percentage for each defined segment; and
defining the cardholders accounts or the transactions which are eligible to be awarded said sweepstake rebates based on transaction volume and/or transaction time for each defined segment.

21. The system of claim 20, wherein the parameter receiving step further comprising the steps of:
defining a linear relationship between an average rebate percentage of each defined segment; and
defining a target average rebate.

22. The system of claim 19, wherein the sweepstake rebate generation step further comprising the steps of:
determining total number and volume of the credit card transactions in each segment;
determining total transaction volume of all segments;
determining an amount limit for awarding sweepstake rebates in each defined segment;
selecting in a dynamic manner the transaction or cardholder to be awarded a sweepstake rebate in each defined segment; and
repeating the selection step until the an amount limit for awarding sweepstake rebates, is reached in each defined segment.

23. The system of claim 22, wherein the dynamic transaction or cardholder selection step further comprising the steps of:
assigning each transaction or cardholder in the segment a sequence number;
generating a uniform distribution dynamic fraction, u(0,1), or u; and
inputting the uniform distribution dynamic fraction, u(0,1), or u, the total number of transactions or cardholders accounts in the segment, TN, into the following equation:
Tₘ=u·TN
to obtain the sequence number of the transaction or cardholder to be awarded the sweepstake rebate.

24. The system of claim 19, wherein the average dynamic rebate amount determining step further comprising the steps of:
adding all transaction volumes of the selected transactions or cardholders accounts in each segment;
determining total sweepstake rebate amount awarded for each segment; and
determining the difference between the rebate amount said credit card issuer desires to award, and the total sweepstake rebates awarded in each segment.

25. The system of claim 21, wherein the dynamic rebate generation step further comprising the steps of:
determining a target average rebate percentage, TRBₙ, for each defined segment based on the card issuer defined average rebate percentage linear relationship; and
dynamically generating a rebate for each transaction or cardholder within each of the defined segment using an algorithm implementing the card issuer assigned distribution curve function.

26. The system of claim 25, wherein the distribution curve function algorithm comprises the steps of:
generating a uniform distribution dynamic fraction, u(0,1) or u;
inputting the variable TRBₙ, or target rebate percentage of segment n, and card issuer selected parameter, X_{nMin}, into the following equations:
MinRₙ=X_{nMin}−TRBₙ
MaxRₙ=(2·TRBₙ)−(X_{nMin}·TRBₙ)
to obtain MinRₙ, which is less than the average rebate percentage, and maximum rebate percentage, MaxRₙ, respectively;
inputting the generated variables u, MinR_{N}, and MaxRₙ, into the following equation:
DRₘₙ=MinRₙ+(MaxRₙ−MinRₙ)·u
to obtain a dynamically generated rebate percentage, DRₘₙ, of transaction, “m”, in segment, “n”;
inputting the dynamically generated rebate percentage, DRₘₙ, and the transaction volume of the corresponding transaction, into the following equation:
DRBₘₙ=TVₘₙ·DRₘₙ
to obtain a dynamically generated rebate amount, DRBₘₙ.

27. The system of claim 25, wherein the distribution curve function algorithm comprises the steps of:
generating a uniform distribution dynamic fraction, u(0,1) or u;
inputting a toughness parameter, k, and the target average rebate percentage, TRBₙ, for the segment, into the following equation:
$$σ = \frac{T R {B}_{n}}{2 \cdot k}$$
to obtain σ;
inputting said uniform distribution dynamic fraction, u(0,1) or u into the following equation:
$$D R {B}_{m n} = \frac{[ {u}^{0.135} - {( 1 - u )}^{0.135} ]}{0.1975}$$
to obtain a dynamic rebate percentage, DRBₘₙ;
inputting said uniform distribution dynamic fraction, u(0,1) or u, DRBₘₙ, σ, a transaction volume of the corresponding transaction, TVₘₙ, and the average rebate percentage into the following equation:
Dynamic Rebate Amount=TVₘₙ[TRBₙ+σ·DRBₘₙ]
to obtain the dynamically generated rebate award amount.

28. The system of claim 15, wherein the processor is further operative for:
storing in said storage device distributed rebate data corresponding to rebates applied to respective credit card transactions of said cardholders;
receiving request from a merchant user for refund amount information corresponding to a revoked transaction of a cardholder;
reading said distributed rebate data corresponding to the revoked transaction;
calculating the refund amount by subtracting the rebate applied to said revoked transaction from the transaction volume of the revoke transaction and; and
transmitting said refund amount information to said merchant user in order to administer a refund to said cardholder.
